(19) United States
(12) Patent Application Publication
(10) Pub. No.: US 2006/0278605 A1
(43) Pub. Date: Dec. 14, 2006

(54) Method of fabricating a lens

(76) Inventor: Manish Sharma, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/153,780

(22) Filed: Jun. 14, 2005

(51) Int. Cl. B29D 11/00

(52) U.S. Cl. 216/24; 216/26

(57) ABSTRACT

The present invention provides a method of fabricating at least one lens. The method comprises providing a substrate with a surface coating. The surface coating is deformable and the method comprises imprinting a structure into the surface coating. The method also comprises etching at least a region of the imprinted structure and the substrate to remove at least a portion of the imprinted structure and the substrate. The structure is shaped so that the etching forms at least a portion of the at least one lens in the structure.

### FIELD OF THE INVENTION

The present invention relates generally to a method of fabricating a lens.

### BACKGROUND OF THE INVENTION

Electronic devices such as computers or television sets have displays for displaying information and images. Such displays often include optical components for imaging the information and images on a screen. In a rear projection display for instance a projector generates an image and a relatively large lens, such as a large Fresnel lens, may be positioned just before the screen to facilitate corner illumination of the screen. Further, the projector itself may include a liquid crystal display (LCD) panel which may be illuminated and imaged using a Fresnel lens.

Fresnel lenses have the advantage that they are relatively flat compared with other types of optical lenses. A Fresnel lens typically has a plurality of concentric rings and each ring may be formed from a plurality of stacked ring-shaped layers. The ring-shaped layers of each ring typically have the same inner diameter but their outer diameter varies in a manner such that the Fresnel lens has a saw-tooth like profile. Each layer of such a stack of layers may have a different refractive index and the layers of each stack need to be aligned relative to each other.

Other types of displays have electron emitters which emit electrons for generation of an image on a screen. Electrons emitted from such electron emitters are guided using electron lenses which are aligned with the electron emitters. In either the optical or the electron optical case alignment processing steps associated with the fabrication of the lenses are cumbersome and complicated. There is a need for technological advancement.

### SUMMARY OF THE INVENTION

Briefly, an embodiment of the present invention provides a method of fabricating at least one lens. The method includes providing a substrate with a surface coating. The surface coating is deformable and the method includes imprinting a structure into the surface coating. The method also includes etching at least a region of the imprinted structure and the substrate to remove at least a portion of the substrate and the base material. The structure is shaped so that the etching forms at least a portion of the at least one lens in the structure.

The invention will be more fully understood from the following description of embodiments of the invention. The description is provided with reference to the accompanying drawings.

### BRIEF DESCRIPTION OF THE DRAWINGS

FIG. 1 is a flow chart illustrating a method of fabricating at least one lens according to an embodiment of the present invention;

FIGS. 2 (a) to 2 (d) shows cross-sectional representations illustrating processing steps of the method of fabricating at least one lens according to an embodiment of the present invention;

FIGS. 3 (a) to 3 (d) shows cross-sectional representations illustrating processing steps of the method of fabricating at least one lens according to another embodiment of the present invention; and

FIG. 4 is a flow chart illustrating a method of fabricating at least one lens according to a further embodiment of the present invention.

### DETAILED DESCRIPTION OF EMBODIMENTS

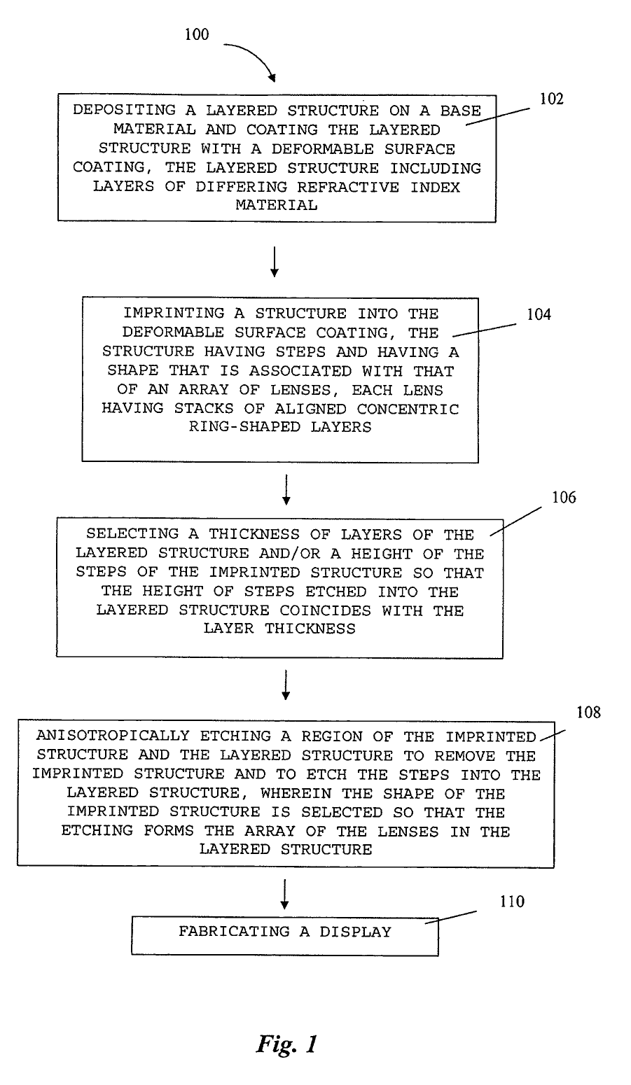

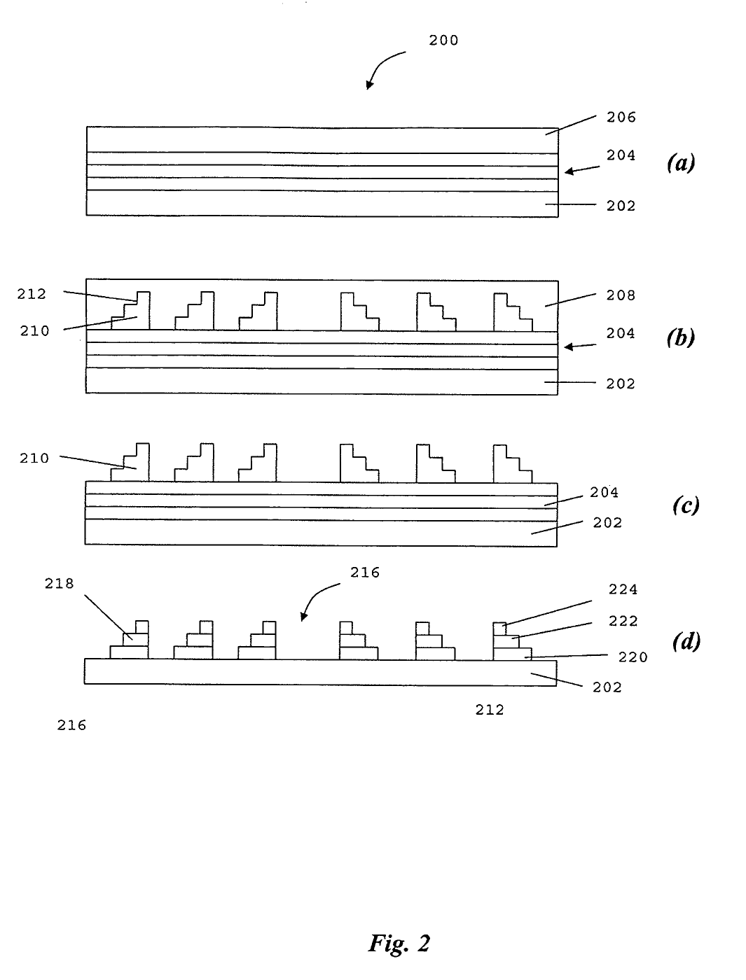

Referring initially to FIGS. 1 and 2, a method of fabricating at least one lens according to an embodiment is now described. The method 100 includes step 102 of depositing a layered structure on a base material and coating the layered structure with a deformable surface coating. The layered structure includes layers of different refractive index. FIG. 2(a) shows an example of such a base material 202, a layered structure 204 and deformable surface coating 206. The deformable surface coating 206 may include a polymeric material that is curable using UV radiation. The deformable surface coating 206 typically is single layered, but may alternatively also include a plurality of layers.

For clarity FIG. 2 illustrates processing steps of the fabrication of one lens only. In this embodiment the layered structure 204 includes three layers but it is to be appreciated that in variations of this embodiment the layered structure 204 may have any suitable number of layers. Further, the layers of the layered structure 204 may, in variations of this embodiment, not necessarily have differing refractive indices.

Step 104 imprints a structure into the deformable surface coating. The structure has steps and has a shape that is associated with a shape of the at least one lens. In this embodiment the shape is associated with that of an array of lenses. Each lens of the lens array is in this example a Fresnel lens having stacks of aligned concentric ring-shaped layers.

Step 106 selects a thickness of the layers of the layered structure and/or a height of the steps of the imprinted structure. The selection is made so that, if the imprinted structure and a portion of the layered structure is etched away and steps are etched in the layered structure, the etched steps have a height that corresponds to the layer thickness of the layered structure.

FIG. 2(b) shows a stamp 208 which imprints a structure 210 into the deformable surface coating 206. The structure 210 is in this simplified illustration associated with the structure of only one lens of the array. The structure 210 that is imprinted into the deformable surface coating 206 has steps 212. After the imprinting the stamp 208 is removed leaving the structure 210 exposed. The structure 210 is then cured using UV radiation.

Step 108 uses an anisotropic etch process to etch the imprinted structure and a region of the layered structure which removes the imprinted structure and a portion of the layered structure 204. For example, the anisotropic etching may be conducted using a directional physical etching processes such as ion beam etching (also referred to as ion milling) or anisotropic reactive ion etching (RIE). It is to be appreciated, however, that alternatively any other suitable etching process may be used which may not necessarily be anisotropic. For example, a chemical etching process may be used. Many chemical etching processes are known and the person skilled in the art will appreciate that the suitability of a particular chemical etching process depends on the material of the layer layered structure and dimensions and shape of the lenses that are etched into the layered structure.

In a variation of this embodiment the shape of the structure may be selected so that only a portion of the lens is formed in the layered structure. In this case the etching typically does not remove the entire imprinted structure but a portion of the imprinted structure remains and forms a part of the lens array.

FIG. 2(d) shows a cross-sectional view of one Fresnel lens which is exemplary for the lenses of the lens array. The shown Fresnel lens 216 includes stacks 218 of concentric-rings. In this embodiment each stack 218 includes three concentric rings 220, 222 and 224 which are formed from respective layers of the layered structure 204. In this example the materials of the layered structure 204 are selected so that the layer 220 has a refractive index that is lower than that of the layer 222. Further, the materials of the layered structure 204 are selected so that the layer 222 has a refractive index that is lower than that of the layer 224.

The method 100 has the advantage that a lens having aligned layers, such as stacks 220, 222 and 224, or an array of such lenses can be fabricated in a simplified manner. The combination of imprinting the structure 210 into the deformable material 206 and the subsequent etching make it possible to fabricate a lens having such aligned layers without separate processing steps in which the layers are aligned relatively to each other.

The method 100 further includes the step 110 of fabricating a display which includes fabricating the array of Fresnel lenses as described above. It is to be appreciated by the person skilled in the art that the fabricated lens array may be incorporated into many types of displays. Once the array has been fabricated, known fabrication steps may follow to fabricate the display. Further, it is to be appreciated that the display may include an array of the lens 216 which are fabricated in accordance with an embodiment of the method 100.

The base material 202 may be formed from a hard material but typically is formed from a flexible material such as a polymeric material that is optically transmissive. The concentric rings 220, 222 and 224 are also composed of optically transmissive polymeric materials and have respective refractive indices as described above.

The method 100 is described in the context of fabrication of a lens array. It is to be appreciated by the person skilled in the art, however, that a variation of the method 100 may be not necessarily fabricate a lens array, but may fabricate a plurality of lenses which may form any suitable arrangement. Further, the arrangement may include any number of lenses and in one specific variation of the method 100 only one lens may be fabricated.

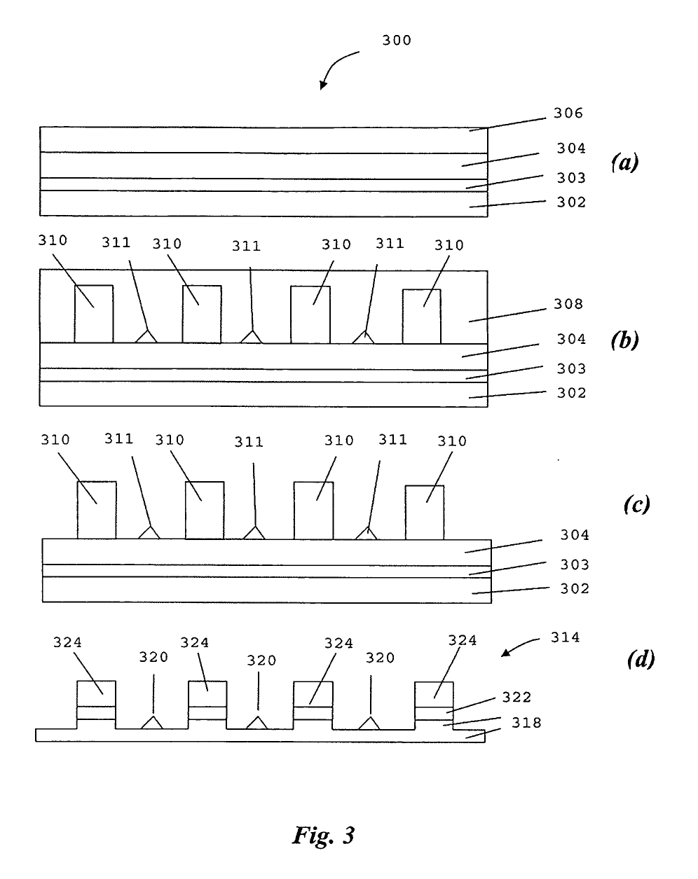

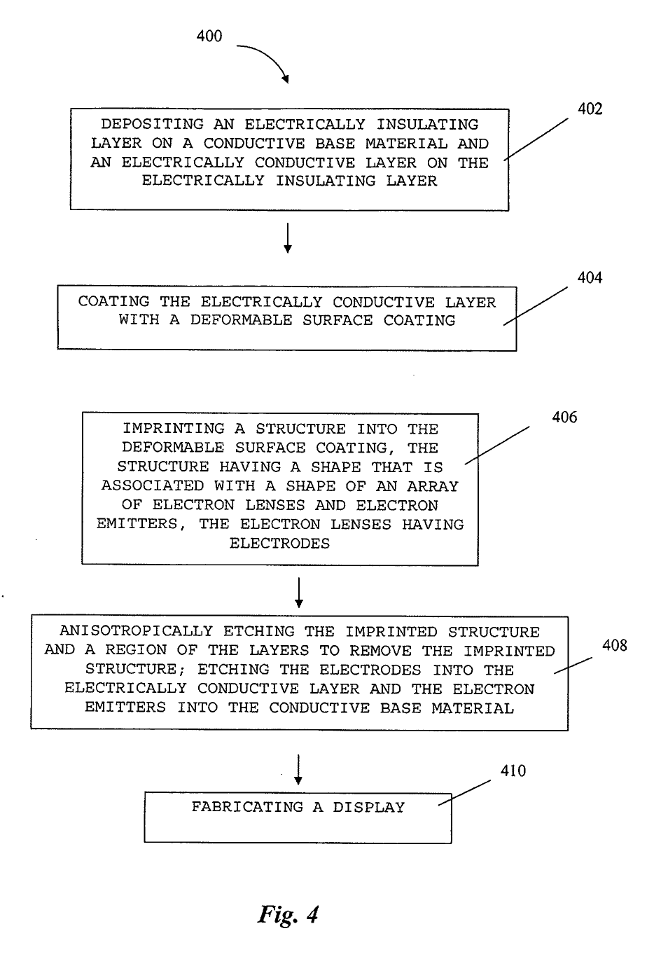

Referring now to FIGS. 3 and 4, a method of fabricating at least one lens according to a further embodiment is now described. Method 400 includes step 402 of depositing an electrically insulating layer on a conducting base material and an electrically conductive layer on the electrically insulating layer. In this embodiment the electrically insulating layer is composed of silica or another suitable insulating material and the electrically conductive layers are metallic.

Step 404 coats the exposed electrically conductive layer with a deformable surface coating. Again, the deformable surface coating may include a polymeric material that is curable using UV radiation.

Step 406 imprints a structure into the deformable surface coating. The imprinted structure is then cured using UV radiation. In this embodiment the structure has a shape that is associated with that of an array of electron lenses and electron emitters. Each lens of the array is in this example an electrostatic electron lens having respective electrodes. It is to be appreciated that in variations of this embodiment the structure may only be associated with the shape of the electron lenses and not with the shape of the electron emitters. For example, a variation of the method 400 may only fabricate the electron lenses and the electron emitters may be fabricated separately.

FIG. 3(a) shows the conductive base material 302 coated with electrically insulating layer 303, electrically conductive layer 304 and a surface coating of deformable material 306. FIG. 3(b) shows a stamp 308 during the process of imprinting the structure 310 and 311 into the deformable material 306. The stamp 308 is removed after imprinting the structure 310. FIG. 3(c) shows the base material 302 with the layers 303 and 304 after the stamp 308 has been removed and the structure 310 and 311 is exposed.

Step 408 etches the imprinted structure and a region of the layers and the base material to form the array of electrodes in the electrically conductive layer and corresponding electron emitters in the base material. In this embodiment the etching is anisotropic and is performed in the same manner as described above in the context of method 100.

FIG. 3(d) show a cross-sectional representation of the formed electron lens array 314. The lens array 314 includes conductive base material 318 in which electron emitters 320 were formed, insulating layers 322 and conductive layers 324 which form electrodes of each electron lens. In this embodiment the insulating layers 322 and the conductive layers 324 form concentric rings positioned around respective electron emitters 320.

The array of electron lenses 314 may include a few electron lenses, but typically includes a relatively large number of electron lenses such as more than 1000 electron lenses. The method 400 is described in the context of fabrication of a lens array. It is to be appreciated by the person skilled in the art, however, that a variation of the method 400 may be not necessarily fabricate a lens array, but may fabricate a plurality of lenses which may form any suitable arrangement. Further, the arrangement may include any number of lenses, with or without electron emitters, and in one specific variation of the method 400 only one lens may be fabricated.

Although the embodiments have been described with reference to particular examples, it is to be appreciated by those skilled in the art that the embodiments may take other forms. For example, the Fresnel lens array may be formed from a material other than a polymeric material. Further, the Fresnel lens array may include any number of concentric rings each being formed from a stack of aligned layers. Each concentric ring may also be formed from only one layer. In addition, it is to be appreciated that only one specific design of the electron lens array has been described and various other designs may be fabricated in variations of the method 400.

1. A method of fabricating at least one lens, the method comprising:
providing a substrate having a layered structure with a surface coating, the surface coating being deformable;
imprinting a structure into the surface coating;
etching at least a region of the imprinted structure and the substrate to remove at least a portion of the structure and at least a portion of the substrate, wherein etching at least a portion of the substrate comprises etching steps into the layered structure, said steps having different heights; and
wherein the layered structure is shaped so that the etching forms at least a portion of the at least one lens in the layered structure.

2. The method of claim 1 wherein providing the substrate further comprises:
depositing at least one layer on a base material and coating an exposed layer with the deformable material.

3. The method of claim 2 wherein:
the base material is a flexible material.

4. The method of claim 2 wherein:
the base material comprises a polymeric material.

5. The method of claim 2 wherein:
the surface coating comprises a polymeric material.

6. The method of claim 1 wherein providing the substrate further comprises:
depositing the layered structure on a base material and coating the layered structure with the deformable material.

7. The method of claim 1 wherein:
the shape of the imprinted structure comprises steps having a height.

8. (canceled)

9. The method of claim 1 comprising:
selecting a thickness of at least one layer of the layered structure into which a step is etched so that the etched step has a height that substantially coincide with the thickness of the layer.

10. The method of claim 7 comprising:
selecting a step height of a step of the imprinted structure so that a step that is etched into a layer of the layered structure has a height that substantially equals the thickness of that layer.

11. The method of claim 1 wherein:
the lens layered structure comprises a stack of aligned layers.

12. The method of claim 1 wherein:
the layered structure of the substrate comprises a plurality of materials of different refractive indices.

13. The method of claim 1 wherein:
the layered structure comprises a stack of aligned ring-shaped concentric layers and the method comprises selecting the layered structure so that aligned ring-shaped concentric layers are formed in the substrate.

14. The method of claim 13 wherein:
the at least one lens comprises optically transmissive materials and is a Fresnel lens.

15. The method of claim 14 wherein:
the at least one lens is an array of Fresnel lenses.

16. The method of claim 28 wherein:
the at least one lens is an electron lens and wherein etching further comprises etching the electrodes into the electrically conductive layer and etching the electron emitters into the conductive base material.

17. The method of claim 16 wherein:
the method comprises forming at least one electron emitter adjacent the at least one electrode.

18. The method of claim 16 wherein:
the at least one electron lens is an array of electron lenses.

19. The method of claim 17 wherein:
the at least one electron lens is an array of electron lenses.

20. The method of claim 1 wherein:
the etching is an anisotropic etching.

21. The method of claim 28 wherein:
the shape of the structure is selected so that the etching forms the at least one lens in the base material and the etching removes the entire imprinted structure.

22. The method of claim 28 wherein:
the shape of the imprinted structure is selected so that the etching forms a portion of the at least one lens in the base material and the etching removes a portion of the imprinted structure.

23. The method of claim 1 wherein:
the shape of the structure substantially equals the shape of the at least one lens.

24. The method of claim 1 wherein:
the surface coating comprises a plurality of layers.

25. A method of fabricating a display comprising the method of fabricating at least one lens of claim 1.

26. A method of fabricating a display comprising the method of fabricating at least one lens of claim 14.

27. A method of fabricating a display comprising the method of fabricating at least one lens of claim 28.

28. A method of fabricating at least one lens, the method comprising:
providing a deformable surface coating on a substrate, said substrate comprising an electrically insulating layer on a conductive base material and an electrically conductive layer on the electrically insulating layer;
imprinting a structure into the surface coating, wherein the imprinted structure comprises a shape that is associated with a shape of an array of electron lenses and electron emitters, wherein the electron lenses have electrodes;
etching at least a region of the imprinted structure and the substrate to remove at least a portion of the structure and the substrate; and
wherein the structure is shaped so that the etching forms at least a portion of the at least one lens in the structure.
